(19) United States
(12) Patent Application Publication
(10) Pub. No.: US 2004/0160691 A1
(43) Pub. Date: Aug. 19, 2004

(54) Master information carrier for magnetic transfer

(75) Inventor: Hideyuki Kubota, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/779,850

(22) Filed: Feb. 18, 2004

(30) Foreign Application Priority Data
Feb. 18, 2003 (JP) 039506/2003

(51) Int. Cl. G11B 5/86

(52) U.S. Cl. 360/16; 360/17

(57) ABSTRACT

A master information carrier includes a substrate having a pattern of protrusions and recesses corresponding to information to be transferred to a slave medium and a magnetic layer formed on the pattern of protrusions and recesses of the substrate. Further, an entire area of the magnetic layer on the pattern of protrusions and recesses is coated with a protective coating and a surface free energy of the protective coating is in a range of 57 mN/m-69 mN/m. A DLC coating is preferable as the protective coating.

### BACKGROUND OF THE INVENTION

1. Field of the Invention

The present invention relates to a master information carrier for magnetic transfer, which is used when information is magnetically transferred from the master carrier which carries the information to a slave medium to which the information is transferred.

2. Description of the Related Art

In the magnetic transfer which is the subject of the present invention, the master information carrier (patterned master) has a magnetic layer at least as a surface layer. A transfer pattern such as a servo signal is formed in shapes of protrusions and recesses in the master information carrier. A magnetization pattern corresponding to the information carried by the master information carrier is transferred to and recorded on the slave medium by applying a magnetic field for transfer while the master information carrier is in close contact with the slave medium having a magnetic recording section.

As an example of the master information carrier used for the above-mentioned magnetic transfer, a master information carrier wherein a pattern of protrusions and recesses, corresponding to an information signal, is formed on a surface of a substrate and a surface of the pattern of protrusions and recesses is coated with a thin magnetic layer has been proposed (refer to, U.S. Patent Laid-Open No. 20010028964 for example)

Here, the basic steps of the magnetic transfer, which is the subject of the present invention, will be described with reference to FIGS. 2A, 2B and 2C. This example shows the steps for in-plane recording. First, a slave medium 2 having a magnetic recording layer, to which the information is magnetically transferred, and a master information carrier 3 as illustrated in FIG. 2B, wherein a pattern of fine protrusions and recesses of a substrate 31 is coated with a magnetic layer 32 thereby forming the pattern of fine protrusions and recesses on the magnetic layer 32, are provided. First, an initial magnetization (direct-current demagnetization) is performed in advance by applying an initial static magnetic field Hin to the slave medium 2 in a single track direction as illustrated in FIG. 2A. Then, a magnetic recording surface of the slave medium 2 and a protrusion pattern of the magnetic layer 32 in the master information carrier 3 are placed in close contact with each other and information is magnetically transferred by applying a magnetic field for transfer Hdu in a track direction of the slave medium 2, in the opposite direction from the initial magnetic field Hin, as illustrated in FIG. 2B. Since the magnetic field for transfer Hdu is absorbed in the protrusions of the pattern formed by the magnetic layer 32, the magnetization in this area is not reversed, whereas the magnetization in the remaining area is reversed. Consequently, the magnetization pattern corresponding to the pattern of protrusions and recesses on the magnetic layer 32 of the master information carrier 3 is magnetically transferred to and recorded on tracks of the slave medium 2 as illustrated in FIG. 2C. Further, the information can be magnetically transferred to the slave medium using a master information carrier having a pattern of protrusions and recesses formed by the magnetic layer, which is substantially similar to the above-mentioned master information carrier also in a perpendicular recording method.

However, the above-mentioned magnetic transfer method has a contamination problem. Specifically, when the aforementioned master information carrier and the aforementioned slave medium are placed in close contact with each other, if the information is magnetically transferred while dust particles or the like are adhered to a surface of the master information carrier and a surface of the slave medium that face each other, the contamination problem arises. Apart of preformat signals in that area is lost without being transferred to and recorded on the slave medium. Consequently, the transfer quality drops.

One of the reasons for the contamination occurrence is the exfoliation or destruction of the magnetic layer formed on the master information carrier. Since the information is magnetically transferred to a large number of slave mediums using a single master information carrier, the master information carrier is repeatedly placed in close contact with the slave medium. A portion of the magnetic layer on the master information carrier exfoliates. The exfoliates adhere to the master information carrier, which causes signal drop-outs due to poor close contact between the master information carrier and the slave medium. Consequently, the reliability of the magnetic transfer drops.

Generally, a protective coating is formed on the magnetic layer to prevent the above-mentioned exfoliation of the magnetic layer. However, if the protective coating is formed only on a surface of the master information carrier which contacts with the slave medium, there are cases in which edges of the magnetic layer exfoliate due to repetitive contacts between the master information carrier and the slave medium. This exfoliation at the edges of the magnetic layer may cause the coating to exfoliate or be destroyed. This is because the edges of the magnetic layer are fragile against lateral forces and in this state, the coating exfoliation easily occurs. Since this causes the contamination, sufficient quality in the magnetic transfer and the durability of the master information carrier can not be ensured.

Further, in the case that the above-mentioned protective coating has the properties that dust particles or the like are easily adhered to its surface, even if the exfoliation of the magnetic layer can be prevented, the contamination problem due to the adhesion of atmospheric dust particles arises. Additionally, it is also required to consider a coating rate (production properties) in forming the protective coating.

### SUMMARY OF THE INVENTION

In view of the foregoing circumstances, it is an object of the present invention to provide a master information carrier for magnetic transfer, which ensures good magnetic transfer and durability by preventing coating exfoliation in the magnetic layer and by forming the magnetic layer in a manner that dust particles will not easily adhere to the magnetic layer, to suppress contamination.

The master information carrier for magnetic transfer according to the present invention includes a substrate having a pattern of protrusions and recesses corresponding to information to be transferred to the slave medium and a magnetic layer formed on the pattern of protrusions and recesses of the substrate, wherein an entire area of the magnetic layer on the aforementioned pattern of protrusions and recesses is coated with the protective coating, and wherein a surface free energy of the protective coating is in a range of 57 mN/m-69 mN/m.

Further, a DLC coating is preferable as the aforementioned protective coating. This protective coating should be a hard coating with a strength of 10 Gpa or greater and preferably 20 Gpa or greater. The coating thickness should be 2 nm-30 nm and preferably 3nm-10 nm. Further, a Si coating or the like may be formed as a layer below the DLC coating.

If the surface free energy is less than 57 mN/m, the durability decreases and contamination can easily occur. If the surface free energy is higher than 69 mN/m, a coating rate is low and coating properties deteriorate. Surface free energy in a range of 60 mN/m-65 mN/m is particularly preferable.

In the present invention, an entire formation area of the magnetic layer is coated with the protective coating; that is, magnetic layer formation area<protective coating formation area. After the magnetic layer is formed on the master information carrier, the protective coating is formed over a wider range than the magnetic layer. The protective coating is also formed on sides of edges in an inner circumference side and an outer circumference side of the magnetic layer.

The above-mentioned condition “magnetic layer formation area<protective coating formation area” can be realized by changing masking areas between the time of forming the magnetic layer and the time of forming the protective coating, for example. Specifically, the aforementioned magnetic layer is formed with masking and at the time of forming the protective coating, the protective coating is formed without masking or by setting a narrower masking area than a masking area at the time of forming the magnetic layer. Accordingly, the protective coating is also formed on the sides of the edges of the magnetic layer.

According to another aspect of the present invention, a method for producing a magnetic disk which carries information represented by a signal pattern includes the steps of initial-magnetizing a magnetic recording layer by applying a magnetic field in a predetermined direction to a disk-shaped slave medium having the magnetic recording layer at least on a surface of a non-magnetic substrate and magnetically transferring information by applying a magnetic field in an approximately opposite direction to the direction in initial-magnetizing while the magnetic recording layer on the slave medium, which has been initial-magnetized and a surface of a disk-shaped master information carrier which includes a substrate having a pattern of protrusions and recesses corresponding to information to be transferred to the slave medium and a magnetic layer formed on the pattern of protrusions and recesses of the substrate are placed in close contact with each other, wherein the entire area of the magnetic layer on the pattern of protrusions and recesses is coated with a protective coating, and wherein surface free energy of the protective coating is in a range of 57 mN/m-69 mN/m.

According to the present invention, the exfoliation of the magnetic layer and the destruction of the edges of the magnetic layer can be prevented by coating the magnetic layer with the protective coating. The contamination due to the exfoliation and the destruction can be suppressed. Further, since the surface free energy has been regulated at 57 mN/m-69 mN/m, the adhesion of the dust particles to the surface can be reduced and contamination can be suppressed while both the durability and the production properties are realized. Hence, high quality magnetic transfer may be realized.

### BRIEF DESCRIPTION OF THE DRAWINGS

FIG. 1A shows a plan view illustrating the schematic construction of a master information carrier for magnetic transfer according to an embodiment of the present invention;

FIG. 1B shows a cross-sectional view illustrating the schematic construction of a major part of the master information carrier for magnetic transfer according to the embodiment of the present invention;

FIG. 2A shows a basic step of magnetic transfer;

FIG. 2B shows a basic step of magnetic transfer; and

FIG. 2C shows a basic step of magnetic transfer.

### DESCRIPTION OF THE PREFERRED EMBODIMENTS

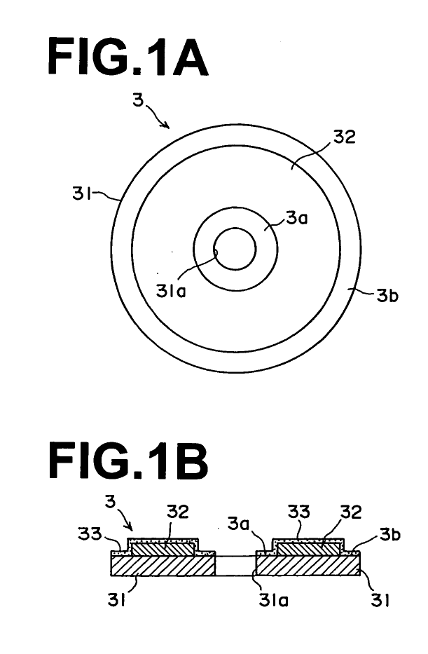

Hereinafter, embodiments of the present invention will be described in detail. FIG. 1A shows a plan view illustrating the schematic structure of a master information carrier according to an embodiment and FIG. 1B shows a cross-sectional view illustrating the schematic structure of the master information carrier according to the embodiment.

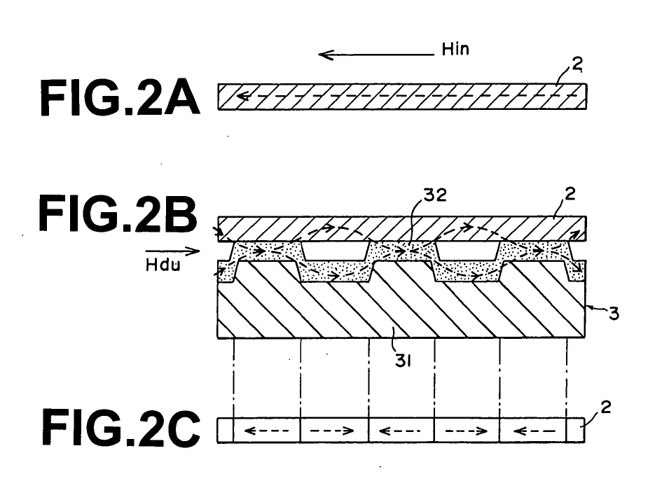

The master information carrier 3 for magnetic transfer according to this embodiment is disk-shaped. A transfer pattern is formed in a ring-shaped area, excluding an unused area 3a in the inner circumference side at a predetermined part of a radius and an unused area 3b in the outer circumference side at a predetermined part of the radius, on the substrate 31 having a center hole 31a. The magnetic layer 32 is formed on a fine pattern of protrusions and recesses corresponding to the information to be transferred in a manner as illustrated in FIGS. 2A, 2B and 2C. Further, the entire surface of the magnetic layer 32 has been coated with a protective coating 33 such as a DLC (diamond-like carbon) coating.

The aforementioned formation area of the magnetic layer 32 is the same or wider area than a formation area of the pattern of protrusions and recesses formed on the substrate 31. An area which is further wider than the formation area of the magnetic layer 32 is completely coated with the protective coating 33. At least the surfaces of the protrusions and recesses, the sides of the edges in the inner circumference side, and the outer circumference side of the magnetic layer 32 are coated with the protective coating 33. Specifically, magnetic layer formation area<protective coating formation area. After the magnetic layer 32 has been formed on the substrate 31, a further wider area is coated with the protective coating 33. The unused areas 3a and 3b are also coated with the protective coating 33 and the sides of the edges in the inner circumference side and the outer circumference side of the magnetic layer 32 are also coated with the protective coating 33 in the case illustrated in FIGS. 1A and 1B.

The formation area of the protective coating 33 may be made wider than the aforementioned formation area of the magnetic layer 32 by forming the magnetic layer 32 with masking to cover the unused areas 3a and 3b and forming the protective coating 33 by removing the masking or narrowing the masking area toward the inner circumference side and the outer circumference side.

Further, a coating with surface free energy in a range of 57 mN/m-69 mN/m is used as the above-mentioned protective coating 33. The protective coating should be a hard coating with strength of 10 Gpa or greater and preferably 20 Gpa or greater. The coating thickness should be 2 nm-30 nm and preferably 3 nm-10 nm. The DLC coating is preferable as the protective coating 33 and a known method such as a CVD method may be adopted as the formation method of the protective coating. A Si coating or the like may be also formed as a lower layer below the DLC coating, that is, on the magnetic layer 32. By changing the composition, coating conditions or the like of the protective coating 33, a protective coating 33 with various surface free energies can be obtained.

If the surface free energy of the protective coating 33 is less than 57 mN/m, as in examples of experiments which will be described later, coating properties are good. However, the durability decreases and contamination can easily occur. If the surface free energy is higher than 69 mN/m, contamination becomes less likely to occur. However, the coating rate is low and coating properties are low.

The fine pattern of protrusions and recesses is formed on the surface of the substrate 31 in the master information carrier 3 by various production methods. The magnetic layer 32 is also formed by various coating formation methods. The depth of the recess (height of the protrusion) in the pattern of protrusions and recesses should be in a range of 50 nm-800 nm and preferably 100 nm-600 nm. The thickness of the magnetic layer 32 should be in a range of 50 nm-500 nm and preferably 75 nm-200 nm.

Nickel, silicon, aluminum, alloy, synthetic resin or the like is used as the substrate 31 in the master information carrier 3. The pattern of protrusions and recesses is formed by a stamper method or the like. In the stamper method, a photoresist is formed on an original plate (silicon wafer, glass plate, quartz plate, etc.), which has a smooth surface, by spin-coating or the like. Next, an electron beam (or laser light) modulated according to a servo signal or the like is irradiated while this glass plate is rotated, and a predetermined pattern such as a pattern corresponding to the servo signal is exposed. Then, the photoresist is developed, an exposed portion is removed and an original disk having the protrusions and recesses made of the photoresist is obtained. Next, plating (electroforming) is applied to a surface of the original disk based on the pattern of protrusions and recesses on the surface of the original disk, a substrate having a positive pattern of protrusions and recesses is produced, and the substrate is peeled off from the original disk.

A substrate having a negative pattern of protrusions and recesses may be produced by producing a second original disk by plating the aforementioned original disk and plating using the second original disk. Further, a substrate having a positive pattern of protrusions and recesses may be also produced by producing a third original disk by plating the second original disk or pressing resin solution to the second original disk, curing the resin solution, and further plating the third original disk. Meanwhile, the substrate may be also formed by forming depressions on the original plate by etching after a pattern made of the photoresist has been formed on the aforementioned original plate, obtaining an original disk by removing the photoresist and thereafter performing the aforementioned steps.

The aforementioned magnetic layer is formed by depositing a magnetic material by vapor deposition method such as a vacuum evaporation method, a sputtering method, an ion plating method or the like. Co, Co alloy (CoNi, CoNiZr, CoNbTaZr, etc.), Fe, Fe alloy (FeCo, FeCoNi, FeNiMo, FeAlSi, FeAl, FeTaN), Ni and Ni alloy (NiFe) may be used as the magnetic material. In particular, FeCo and FeCoNi are preferable.

In a magnetic transfer device, the above-mentioned master information carrier 3 is placed in close contact with the slave medium 2 which has been initially-magnetized in advance in a track direction or a perpendicular direction in the aforementioned basic steps shown in FIGS. 2A, 2B and 2C. A magnetic field for transfer is applied to the master information carrier 3 by a magnetic field applying device such as an electromagnetic device in substantially the opposite direction from the initial-magnetization direction while the master information carrier 3 and the slave medium 2 are placed in close contact with each other. Thereby, a magnetization pattern corresponding to the transfer information of the master information carrier 3 is transferred to and recorded on the slave medium 2.

According to the present embodiment, the exfoliation or the destruction of the edges of the magnetic layer 32 may be prevented by forming the protective coating 33 with which the magnetic layer 32 is completely coated. Further, since the surface free energy has been regulated at 57 mN/m-69 mN/m, the durability can be ensured and adhesion of dust particles to the surface can be reduced. Further, the contamination occurrence due to foreign objects existing between the contact surfaces of the master information carrier 3 and the slave medium 2 can be suppressed. Hence, the high quality magnetic transfer may be realized.

Next, experiments related to the formation of the protective coating for the magnetic layer in the master information carrier, where durability evaluations and a range of the surface free energy properties have been obtained, will be described. In the experiments, the surface of the master information carrier has been observed after durability experiments on the protective coatings (mainly DLC coatings) with various surface free energies. TABLE 1 shows a result of comparisons between coating rates and numbers of foreign objects adhering to the surface of the master information carrier.

<Magnetic Layer Formation>

The magnetic layer is formed by a DC sputtering method. Fe—Co (70-30 atomic percent) is used as a target and a coating with a thickness of 200 nm is formed. The substrate should be cleaned before forming the magnetic layer. The substrate should preferably be cleaned within a deposition chamber, in which the magnetic layer is formed.

When the magnetic layer is formed, the substrate is set in a substrate holder. At this time, the masking is provided in an area in an outer circumference side and an area in an inner circumference side of the substrate so that the pattern of protrusions and recesses, i.e., signal area, formed on the substrate is not covered. As a masking method, it is preferable to set a detachable masking tool in the substrate holder and realize a mechanism which can enable attachment or detachment of the masking in a vacuum. Since the magnetic layer is formed by using the above-stated masking tool, the magnetic layer is formed on the entire surface of the pattern of protrusions and recesses. However, the magnetic layer is not formed in the unused areas in the inner circumference side and the outer circumference side of the substrate.

A typical coating condition of the magnetic layer is with a pressure at the time of coating of 0.29 Pa, a DC power of 1.5 kW and a target to substrate distance of 200 mm.

<Protective Coating Formation>

The DLC coating is formed as the protective coating by using an ion beam gun. A typical coating condition of the protective coating is with a process gas composition including ethylene at 5 sccm+argon at 20 sccm, an accelerating voltage of 90 V and a sputter pressure of 0.20 Pa. DLC protective coatings with various surface free energy characteristics are formed by changing these coating conditions.

Here, as a method for forming the protective coatings with various surface free energies, an anode argon flow is changed. Specifically, in the case of the DLC coatings, a coating with a high surface free energy can be formed by increasing the anode argon flow and a coating with a low surface free energy can be formed by decreasing the anode argon flow. When a process gas flow increases, the ethylene is carrierized (ionized) at high efficiency. Therefore, a DLC coating which adheres to the magnetic layer substantially evenly is formed and the surface with a high surface free energy is formed. On the contrary, when the process gas flow decreases, carrier efficiency drops. Therefore, the DLC coating adheres to the magnetic layer in various states. Consequently, a DLC coating with a low surface free energy is formed.

The master information carrier with the protective coating formed with various surface free energies has been obtained by changing the coating conditions as shown in TABLE 1. Other coating conditions are with argon for neutralization at 7 sccm, an anode electric current of 7.0 A, a substrate to ion gun distance of 17.78 cm (7 inch) and a coating thickness of the protective coating of 100 nm.

It is preferable that the magnetic layer and the protective coating are consecutively formed within the same chamber to prevent the adhesion of contaminants to the master information carrier. The protective coating is formed by removing the masking tool which has been used in forming the above-stated magnetic layer. Accordingly, the protective coating can be formed in a wider area than the magnetic layer and a protective coating area that covers the entire magnetic layer area can be produced.

<Surface Free Energy Measurement>

A contact angle on a surface of the protective coating was measured using purified water and methylene iodide as reagents and the result was converted to the surface free energy.

<Coating Rate>

A coating speed has been evaluated from a view point of production properties. The coating rate (speed) has been evaluated as ⊚ (excellent) for 1.0 nm/sec or higher, ◯ (good) for 0.1 nm/sec-1.0 nm/sec and Δ (acceptable) for 0.1 nm/sec or lower.

<Master Information carrier Surface Observation after Durability Test>

Durability tests of repetitive contacts with the slave medium were performed using the master information carriers which were produced in the above-mentioned manner. The contact state is that in which forces are applied between the master information carrier and the slave medium approximately at 1.2 kN (120 kgf) and the master information carrier and the slave medium are repeatedly contacted with each other. A general hard disk medium (2.5 inch size, coercive force of 278 kA/m(=3500 Oe), surface free energy=55 mN/m) was used as the slave medium.

The above repetitive contacts were performed 1000 times and after the repetitive contacts, the master information carriers were observed by using strong halogen light. Numbers of foreign objects which can be judged as adhesive objects were counted and relative comparative evaluations of the numbers were performed. The numbers were evaluated as X (failure) for the largest number, Δ (acceptable) for approximately ½ of the largest number, ◯ (good) for approximately ¼ of the largest number and ⊚ (excellent) for approximately ⅛ of the largest number.

<Evaluation Result>

Based on the result in TABLE 1, the surface free energy of the protective coating should be in a range of 57 mN/m-69 mN/m and preferably 60 mN/m-65 mN/m to realize both the durability and the productivity. If the surface free energy is less than 57 mN/m, the durability decreases and the contamination can easily occur. If the surface free energy is higher than 69 mN/m, the coating rate is low and the coating properties deteriorate.

TABLE 1

| | | | | | Evaluation Results | | |
|---|---|---|---|---|---|---|---|
| | | | | | Surface | | |
| | Coating Conditions | | | | Free | | |
| | Pressure | Accelerating | Ethylene | Anode Ar | Energy | Coating | Surface |
| | (Pa) | Voltage (V) | (sccm) | (sccm) | (mN/m) | Rate | Observation |
| Sample 1 | 0.47 | 90 | 5 | 75 | 69 | Δ | ∘ |
| Sample 2 | 0.34 | 90 | 5 | 50 | 65 | ∘ | ∘ |
| Sample 3 | 0.21 | 90 | 5 | 25 | 60 | ∘ | ∘ |
| Sample 4 | 0.17 | 90 | 5 | 15 | 57 | ⊚ | Δ |

What is claimed is:

1. A master information carrier for magnetic transfer comprising:
a substrate having a pattern of protrusions and recesses corresponding to information to be transferred to a slave medium; and
a magnetic layer formed on the pattern of protrusions and recesses of the substrate, wherein:
the entire area of the magnetic layer on the pattern of protrusions and recesses is coated with a protective coating; and
surface free energy of the protective coating is in a range of 57 mN/m-69 mN/m.

2. The master information carrier for magnetic transfer, as defined in claim 1, wherein a DLC coating is used as the protective coating.

3. A method for producing a magnetic disk which carries information represented by a signal pattern, the method comprising the steps of:
initial-magnetizing a magnetic recording layer by applying a magnetic field in a predetermined direction to a disk-shaped slave medium having the magnetic recording layer at least on a surface of a non-magnetic substrate; and
magnetically transferring information by applying a magnetic field in an approximately opposite direction to the direction in initial-magnetizing while the magnetic recording layer on the slave medium, which has been initial-magnetized and a surface of a disk-shaped master information carrier which includes a substrate having a pattern of protrusions and recesses corresponding to information to be transferred to the slave medium and a magnetic layer formed on the pattern of protrusions and recesses of the substrate are placed in close contact with each other, wherein:
the entire area of the magnetic layer on the pattern of protrusions and recesses is coated with a protective coating; and
surface free energy of the protective coating is in a range of 57 mN/m-69 mN/m.
